(19) United States
(12) Patent Application Publication
(10) Pub. No.: US 2011/0004637 A1
(43) Pub. Date: Jan. 6, 2011

(54) MOBILE DATA AND SOFTWARE UPDATE SYSTEM AND METHOD

(75) Inventors: Robert O'Farrell, Woodinville, WA (US); Mark D. Kirstein, Incline, NV (US); Robert Gryphon, Incline Village, NV (US); Brian Browder, Incline, NV (US); Stanley Liu, Incline, NV (US); Patrick E. O'Farrell, Selah, WA (US); Geoff O'Farrell, Kirkland, WA (US); Alison Clark, Leavenworth, WA (US); David Loren Shoup, Woodinville, WA (US); Brian Philbin, Snohomish, WA (US)

Correspondence Address: Barry G Magidoff, Esq., Paul J. Sutton, Esq.;Sutton Magidoff LLP, 909 Third Avenue - 27 FL, New York, NY, 10022, US

(73) Assignee: Antenna Dexterra, Inc.

(21) Appl. No.: 12/776,849

(22) Filed: May 10, 2010

Related U.S. Application Data
(63) Continuation of application No. 10/746,229, filed on Dec. 23, 2003, now abandoned.
(60) Provisional application No. 60/436,230, filed on Dec. 23, 2002.
(60) Provisional application No. 60/442,810, filed on Jan. 23, 2003.
(60) Provisional application No. 60/461,588, filed on Apr. 7, 2003.

(51) Int. Cl. G06F 17/30

(52) U.S. Cl. 707/809; 707/E17.006; 707/E17.045

(57) ABSTRACT

Data is shared between multiple enterprise data sources and mobile clients in a distributed system such that requests from a mobile client for enterprise data are received, the appropriate enterprise data sources that contain the requested data are determined, and the enterprise data is retrieved from the determined enterprise data sources. When the enterprise data is retrieved, it is converted into a relational format that can relate the retrieved data, even if the data comes from multiple enterprise data sources. The converted enterprise data is stored in a relational data store in the mobile client. In this way, mobile applications can be fully integrated with data from multiple enterprise data sources and data updates and configuration changes can be distributed to and from the mobile clients in real-time, without using interim data storage, and thereby avoiding complicated synchronization and data conflict issues between the enterprise data sources and the mobile clients.

### REFERENCE TO PRIORITY DOCUMENTS

This application claims the benefit of priority of these co-pending U.S. Provisional Patent Applications: Ser. No. 60/436,230 entitled “Business Process User Interface System and Method” filed Dec. 23, 2002; Ser. No. 60/442,810 entitled “Context Sensitive Data Update System and Method” filed Jan. 23, 2003; and Ser. No. 60/461,588 entitled “Context Sensitive Data and Software Update System and Method” filed Apr. 7, 2003. Priority of the filing dates are hereby claimed, and the disclosures of the Provisional Patent Applications are hereby incorporated by reference.

### BACKGROUND

1. Field of the Invention

The present invention relates generally to mobile computing systems and, more particularly, to data management and data deployment in mobile computing systems.

2. Description of the Related Art

In recent years, many resources have been invested in the automation of back office and front office processes. For example, large sums of money have been spent on developing and purchasing sophisticated customer relationship management (CRM) and enterprise resource planning (ERP) systems. Although many organizations found the systems burdensome to implement and difficult to integrate with existing legacy data systems, many companies realized significant savings and efficiencies. These improvements helped contribute to widespread technology-led productivity increases.

The office process automation efforts have typically been focused on many customer-critical processes, where an organization interfaces with customers, but the efforts have largely stopped at the company front door. More recently, many organizations are striving to bring the benefits of automation to the least automated segments of their workforce: their mobile employees. These workers play a major role in a customer's perception of an organization. Currently, the extent of automation and enforced business processes for such workers has been limited to mobile computing devices such as pagers and cell phones.

Mobile computing can provide substantial benefits for an information-driven enterprise that has field staff who meet customers. For example, field staff productivity can be radically increased, and critical business processes such as ordering and service scheduling can be dramatically accelerated, by providing field staff with mobile computing devices. Many enterprises who are early adopters of such mobile computing systems have discovered that these benefits often come with a substantial cost. Some of the major difficulties faced by adopters of mobile platforms involve integration with other data in the enterprise.

Enterprise data integration issues can arise because mobile applications often come in proprietary, closed architectures that impede integration with other data systems of the enterprise. For example, data in the enterprise might be maintained in four or five different sources. Some of the data sources include CRM systems, dispatch systems, ERP systems, and financial records systems. Each of these data sources can utilize a different data architecture, format, and protocol. The data being stored and the configuration of the data and access mechanisms are constantly changing. Many mobile computing systems create an interim datastore in which data from the various sources in the enterprise is collected. In this way, data from the different enterprise data sources, each with a different data architecture and format, can be collected in a single common database. The mobile users can access the enterprise data by accessing the interim datastore, rather than the actual enterprise data sources. The interim store, however, creates data update and conflict issues of its own. Synchronization operations and other safeguards must be performed frequently, to ensure that the data in the interim datastore is a faithful copy of the data in the enterprise data sources.

As a result of these difficulties and increased complexity, there is renewed emphasis on requiring mobile applications to be fully integrated with other applications and data, and to have greater functional capabilities. The present invention satisfies these needs.

### SUMMARY

In accordance with the invention, data is utilized between multiple enterprise data sources to mobile clients in a distributed system such that requests from a mobile client for enterprise data are received, the appropriate enterprise data sources that contain the requested data are determined, and the enterprise data is retrieved from the determined enterprise data sources. When the enterprise data is retrieved, it is converted into a relational format, even if the data comes from multiple enterprise data sources of different non-relational types (e.g. File System, email, etc). The converted enterprise data is stored in a relational datastore in the mobile client. In this way, mobile applications can be fully integrated with data from multiple enterprise data sources and data updates and configuration changes can be distributed to and from the mobile clients in real time, without using interim data storage, and thereby avoiding complicated synchronization and asynchronous data issues between the enterprise data sources and the mobile clients. The real time data changes can include deployment of changes to the mobile application itself, as well as data updates. The real time changes are further accommodated with data conflict detection and resolution.

Other features and advantages of the present invention should be apparent from the following description of the preferred embodiment, which illustrates, by way of example, the principles of the invention.

### BRIEF DESCRIPTION OF THE DRAWINGS

The advantages of the invention will become more readily appreciated and become better understood by reference to the following detailed description, when taken in conjunction with the accompanying drawings, wherein:

FIG. 1 is a block diagram of a suitable computer system environment for a mobile enterprise platform constructed in accordance with the present invention.

FIG. 2 is a block diagram of the logical architecture of data in the mobile enterprise platform illustrated in FIG. 1.

FIG. 3 is a block diagram that illustrates the Connector interface between the enterprise data sources and the mobile client of FIG. 1.

FIG. 4 is a screen display for a Business Objects window of the Administrator component application of FIG. 1.

FIG. 5 shows a screen display for a Groups window of the Administrator application.

FIG. 6 shows a screen display for a Security Settings window of the Administrator component in FIG. 1.

FIG. 7 shows a screen display for a Metrics window of the Administrator component.

FIG. 8 illustrates a display screen for a “Queue” page that is generated at the mobile client of FIG. 1 to show a repair queue of customers who have requested a service call.

FIG. 9 shows the Queue display page of the mobile client device with a customer launch operation initiated.

FIG. 10 shows an Overview display page of the mobile application for a client selected from the queue of FIG. 9.

FIG. 11 shows a Product History display page of the mobile application, providing information for a product to be serviced.

FIG. 12 shows a Details display page of the mobile application for the service call selected from FIG. 9.

FIG. 13 shows a Parts display page of the mobile application for the service call selected from FIG. 9.

FIG. 14 shows a Totals data collection display page of the mobile application for the service call selected from FIG. 9.

FIG. 15 shows a Signature display page of the mobile application for the service call selected from FIG. 9.

FIG. 16 shows a Queue display page of the mobile application after completion of the service call selected from FIG. 9.

FIG. 17 is a flow diagram that illustrates operation of the mobile enterprise platform to share data between multiple enterprise data sources and mobile clients.

### DETAILED DESCRIPTION

### I. System Overview

The present invention provides a system in which data is utilized from multiple enterprise data sources to mobile clients executing mobile applications such that the mobile applications are integrated with the multiple enterprise data sources, and data updates and configuration changes can be distributed to and received from the mobile clients in real time, without using interim data storage. The elimination of an interim data storage facility avoids complicated synchronization and asynchronous data issues between the enterprise data sources and the mobile clients. Thus, data updates and system configuration updates for the mobile application can be communicated from the enterprise to the mobile clients, and from the mobile clients to the enterprise, in real time. No special synchronization operation is needed, as changes can be propagated through the system in real time.

### II. System Platform

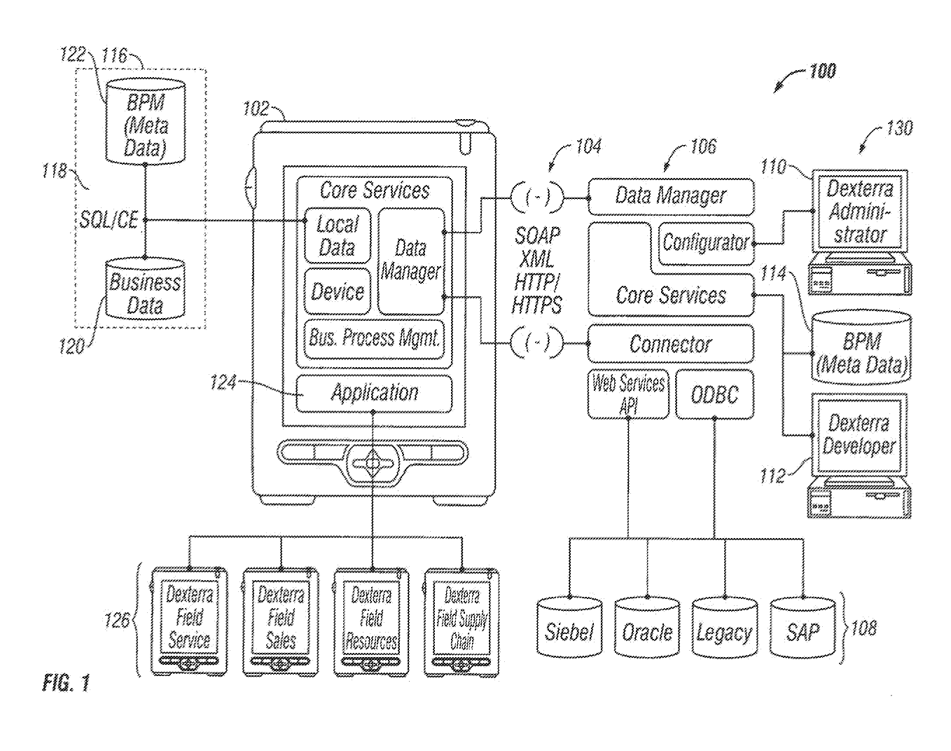

FIG. 1 is a block diagram of a suitable computer system environment 100 constructed in accordance with the present invention. FIG. 1 shows a mobile client device 102, such as a Personal Digital Assistant (PDA) device that operates in conjunction with the Microsoft PocketPC or Palm PDA operating systems. The mobile client device communicates over a network connection 104 with an application server 106 to request data from the server and receive data updates, provide new data, and receive configuration changes. It should be understood that multiple mobile clients 102 can communicate with the server 106. Only a single client device 102 is shown in FIG. 1 for the sake of drawing simplicity.

The mobile clients 102 consume the server-side connector web services for real time data retrieval from multiple enterprise data stores. Additionally, the mobile clients consume the server-side data manager web services for the management of real-time client-side data updates, server side data updates and system configuration updates.

The application server 106 communicates with enterprise data sources 108, such as CRM data sources, ERP sources, financial system resources, legacy data stores, and the like. The exemplary enterprise data sources illustrated in FIG. 1 include data including “Siebel” software from Siebel Systems, Inc. of San Mateo, Calif., USA; “Oracle” software from Oracle Corporation of Redwood Shores, Calif., USA; “SAP” software from SAP AG of Walldorf, Germany; and legacy software. The administrator application 110 and a developer application 112 communicate with the application server 106, which also stores metadata 114 for the system, as described further below.

The application server 106 provides data manager, configuration, and data connector web services for data interchange and updating, user authentication, security, and logging services. The application server also handles business process management in the form of business information and rules.

The mobile client 102 also includes a datastore 116 that includes a relational data base 118 that stores business data 120 and also a relational database that stores metadata 122 for application execution on the mobile client. An application 124 that is installed at the mobile client 102 includes various software components that perform suitable functions. For example, the application might comprise a field service application that informs field service personnel as to a location at which service has been requested, explains the nature of the service request, and provides for logging the service visit and settling the account. The application 124 may include multiple applications that process the data requested by the mobile client 102.

The administrator application 110 and developer application 112 together comprise a “Studio” component 130. In the illustrated embodiment, the administrator and developer are provided as two separate applications, and provide a means to configure the system, including the metadata data and application interfaces.

The system 100 comprises a mobile enterprise platform that supports the service application 124. The system provides a set of Web services that effectively deploy and manage mobilized software solutions to enhance mobile business processes. Common examples include integrating to CRM or ERP, sales force automation (SFA), and customer support and help desk functions for an enterprise. Such enterprise applications depend on cross-application interaction, in that data from one function or system is often used by a different function or system. When executed on the mobile client, the existing application functionality and enterprise information is utilized among multiple enterprise software applications, legacy data systems, and mobile workers. In this way, a significant return on investment can be achieved for these applications and for the mobile enterprise platform.

The mobile enterprise platform 100 provides Web services that simplify the use of mobile clients and associated portable devices in the field. These Web services include a data manager function, a configuration function, and a connector function. These will be described in greater detail below. The applications 124 that are installed on the mobile clients 102 can be fully functional in any connected or disconnected state, after they have been properly initiated by the application server 106.

### III. Logical Architecture

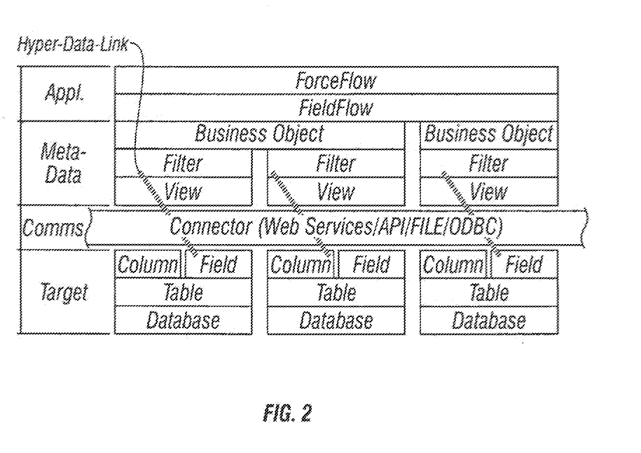

Any client application that makes use of the Mobile Enterprise Platform illustrated in FIG. 1 will utilize the system components illustrated in the block diagram of FIG. 2. These components include:
Business Objects—programmable objects based on business concepts, combining fields and relating information from different enterprise data sources. (e.g. data sources such as Customer, Contacts, Assets, Tasks, etc.).
Business Rules—custom logic to enforce business processes utilizing business constants with checks applied against business data from the enterprise data sources.
Business Constants—A user-configurable variable for use throughout the client applications, and client and server-side business rules (e.g. Business Rules, Warning Messages, and the like).
Datasource Connectors—data source connectors designed to seamlessly provide access to a wide variety of enterprise data sources (e.g. databases such as those formatted according to Oracle and SQL Server, messaging systems such as MQ Series or MSMQ, CRM applications such as Siebel or Peoplesoft, generic web services, and so forth).
Business Process—metaphors, such as a “Force Flow” process of Dexterra, Inc. of Bothell, Wash., U.S.A., that defines a form-to-form navigation paradigm for modeling business processes.
Forms—a combination of standard visual display screens (e.g., View, Edit, Find, and the like) with event driven logic that are designed to show information, gather information, and direct the user through a given business process, referred to herein as either a “ForceFlow” or a “FieldFlow”.
Views—A modifiable representation of the data identified from an enterprise datasource or application that is utilized by one or more Business Objects.
Filters—A Filter that can be applied to a View to modify the data available to a Business Object.

These components can be used to specify the configuration (logical architecture) of any client application that is constructed utilizing a technology framework such as the Microsoft Corporation “.NET” and tools such as Microsoft Corporation's “Visual Studio.NET”. Those skilled in the art will be familiar with such programming tools to specify an application and its associated data objects.

The Mobile Enterprise Platform illustrated in FIG. 1 is implemented as a metadata driven framework. The framework provides integrated client and server web services, enabling the connection, configuration, and data management services necessary to deploy fail-safe, mission-critical mobile enterprise solutions.

FIG. 2 illustrates that, in the mobile enterprise platform of FIG. 1, the structure of relational database tables and external application business objects are mapped to views as metadata. One or more views are consumed by Business Objects, also defined in metadata, which are in turn utilized by the mobile application. The mobile application utilizes a client framework, referred to as the “Dexterra Smartclient”, which manages the instantiation of the Business Objects, Local Data Access to the underlying physical database that resides on the mobile client device, Device integration, as well as the client-server data communication via the data manager and/or connector web services. Within the platform, specifications for all logical layers (e.g., Business Objects, Views, Filters, and Connectors) are defined and maintained within the metadata.

The mobile enterprise platform is architected as a logical stack, designed to insulate layers in the logical architecture from all but non-adjacent members. At the bottom of the logical stack, the Target layer, is data that resides in back-end, enterprise data sources. The platform works with the source data in place, and does not require information within the back-end system of record to be replicated to a middle-tier replication database. That is, no interim datastore is needed. This provides flexibility in design, as well as real time data access and can help reduce total cost of ownership of the platform and applications, and assists simplification of data management processes.

The next layer up in the logical stack is the Connector layer. The Connector layer provides a programmatic construct that describes the back-end datastore to the application server in a relational format. The information regarding how to connect to an enterprise data source, as well as the security settings (such as authentication methods and user and group definitions) are stored within metadata, and are maintained using the Administrator component.

The next layer in the stack is the View layer, which comprises objects that provide a one-to-one mapping to an object or table in a back-end, enterprise data source. For example, if a back-end system has a table called CUST_ADDR (customer address), and data from that table is required for use in an application, then a View will be created in the Administrator component. The Administrator View might be called, for example, CUSTOMER_ADDRESS, to represent that data in the environment of the mobile enterprise platform, outside of the enterprise data sources. It should be understood that a View has properties that correspond to the properties or columns of the data object in the back-end system. However, it is not required that all properties in the back end data source are required as properties in the View. Indeed, the properties required are defined in the administrative component and stored as metadata In the example just provided, the properties might include fields such as ID, STREET_ADDR, CITY, STATE, and ZIP_CODE.

Additionally, the user can define the data types of the properties within the View, and these data types can be independent of the data types of the corresponding properties in the enterprise data source. Other options of the view properties that can be identified are unique identifier, read only, indexing, required property and length. All the above information is stored as metadata.

The View layer also provides an indication of data conflicts, and provides a means for resolving such conflicts. Data conflicts can occur, for example, whenever there are data changes between what is being uploaded from the mobile client and what exists at the server. Resolution of such conflicts can be performed at the View layer, enforcing business rules such as permitting the most recent data change to always take precedence, or permitting data changes from a particular source (e.g., either the mobile client or an enterprise data source) to take precedence depending on the data type (e.g. field data or customer account data). This is described further below, in conjunction with the Data Manager Web Service.

As illustrated in FIG. 2, the Views can be defined against multiple objects in multiple datastores, thus providing flexibility in application deployment and in the use of in-place systems, without the burden of data replication. As with the Connectors, the definitions of Views are stored in metadata, and are managed with the Administrator. Those skilled in the art will understand details of data definitions in metadata, without further explanation. As noted above, Filters can be applied to the Views, to modify the data that is passed to the next layer. The Administrator provides View management features, including a Views Wizard that automatically creates Views based upon the object interface or table definition of the back-end datastore objects (from the enterprise data sources).

The next layer up in the FIG. 2 diagram includes the Business Objects, which are mapped, or associated with, one or more Views. A Business Object of the platform is the programmatic entity with which a developer will interface with when building customizing mobile applications. The Business Objects include multiple properties, each of which can be of a simple data type, or can be another Business Object. Because the Business Objects of the platform can be mapped to multiple Views, developers can work with a single entity that represents data sourced from multiple, heterogeneous data sources. Thus, a single Business Object defined in accordance with the mobile enterprise platform of the invention can include data from multiple, potentially incompatible enterprise data sources, such as from different proprietary formats.

In creating or modifying applications for the mobile applications and mobile client devices, developers can interact solely with the Business Object layer. This insulates the developers from any requirement to understand or interact directly with the back-end systems (enterprise data sources) for the source data. In this way, the Business Object layer provides an object-based interface for application developers, abstracting the details of persistence and retrieval of data. There is no need for the developer to directly interact with the local datastore on the mobile device. In addition, due to the nature of disconnected data, the mobile client, through the Business Object interface, automatically manages the processing of data changes, by storing data changes locally in the client that will be passed to the application server during an Update process. This further insulates developers from this rote programming task.

The Business Objects exist on the mobile client device as metadata, and are also managed using the Administrator (FIG. 1). The use of metadata throughout the mobile enterprise platform provides an environment in which the attributes and behavior of most data entities can be configured through a graphical user interface rather than coded.

The metadata-driven nature of the mobile enterprise platform enables performing business processes on the mobile client through a stateless server architecture. Through the metadata, the mobile application can be configured and customized. The metadata defines the structure of the business objects referencing the business enterprise data to the mobile device and defines the events that trigger business rules that govern the business processes.

The metadata database contains the reference of the cross-functional, cross-application back-end business information that is exposed through the Connectors to configure a business object. This process is accomplished through the Studio component (FIG. 1) to configure and reference the connecting enterprise data source business information with the Business Objects. This provides the path to the specific data for the mobile applications, ensuring that no business data from an enterprise data source is stored in its native data format on the application server or on any other interim datastore of the system for data updates. This non-invasive and real time synchronous approach using the metadata permits the mobile enterprise platform to effectively connect to back-end systems with a minimum amount of disruption while maximizing cross-functional data access, data consistency, and data integrity.

### IV. Mobile Enterprise Platform Components

A. Mobile Applications

As noted above, the mobile client 102 (FIG. 1) can include installed applications 124 that implement business processes of the enterprise. The application can leverage the mobile enterprise platform described above, and demonstrates how the application instantiates the business objects which drive the business process configured in metadata.

For example, Task or Work Order information would be provided to the mobile application through views and would be accessed via a business object. In retrieval of the business data via the view definition, using the data manager web service, the business object can deliver the business data to the mobile application to describe the tasks. This data is stored on a local relational database on the mobile device. When an update to the task data is committed to the task business object in a request from the application, the Smartclient application will persist the changes to the view defined datastore on the mobile client, then the Smartclient manages the data updates back to the original data source via the data manager web service, ensuring data integrity and consistency.

By utilizing the depth, breadth, and power of web services (e.g., connection, configuration, and data manager services) that are available in the mobile enterprise platform described herein, a large suite of mobile applications can easily be constructed, including applications such as sales force productivity, customer service, and support solutions. Such applications can be integrated with a broad set of vertical applications including oil/gas, healthcare/medical and financial service industry solutions.

B. Server Components

The application server is a type of metadata-driven platform application and provides information, applications, and business processes to the mobile client, and ensures managed data integrity between the mobile enterprise platform and a host of back-end enterprise data sources. The application server is a process-based, high performance solution built on the “.NET” technology from Microsoft Corporation of Redmond, Wash., U.S.A. Using the “.NET” technology, the mobile enterprise solution is a framework that is Web Services native through the use of XML and SOAP for data exchange and transport. The application server provides three core Web Services, as shown in the functional architecture diagram of FIG. 1:

Connector Web Service
The Connector Web Service delivers non-invasive integration of the existing enterprise applications infrastructure while maintaining control of the Data-Integrity Conditions between the mobile clients and the discrete enterprise data sources.

Configuration Web Service
The Configuration Web Service manages the metadata defining the business data, business objects, business rules, business constants, and system configuration such as authentication, logging, security, and roles that encompass the mobile applications that are passed to the mobile client—the component application that is resident on the mobile device.

Data Manager Web Service
The Data Manager Web Service orchestrates the update interactions between the mobile client application, the application server, and the third-party enterprise data sources. Additionally the Data Manager Web Service provides the ability to directly communicate with the connector layer for real-time queries. The Data Manager Web Service delivers flexibility in the manner that manages the various conditions concerning multiple updates by multiple users to the multiple enterprise data sources to enforce the integrity of the data. The Data Manager Web Service can do this via the application server or direct to any API and/or third-party published Web Service.
In this way, the Data Manager Web Service can manage deployment of application updates and data changes throughout the mobile clients of the system.
Each of these components will next be described in greater detail.

1. Connector Web Service

The Connector Web Service is designed to support communication with any ODBC-compliant data source or Web Service API. The Connector Web Service allows a customer to define and build views based on data stored in one or more third-party systems. The Connector Web Service has a published interface that allows for standard bulk updates as well as real-time data access from a mobile client.

The Connector Web Service provides the physical layer connection between the application server meta-application and the specific interface of the enterprise data sources. The connectors support database dispute management and notification services, transaction management, and error handling. In a default customer configuration, the mobile enterprise platform system is deployed to customers with an ODBC or Web Service connector. Those skilled in the art will be able to produce connectors to the most common enterprise systems, such as Siebel, SAP, PeopleSoft, Oracle, SQL Server, and the like.

For example, an “Oracle” applications connector allows a customer to make calls to Oracle support services, either through the closest data constructs the customer has to APIs (such as PL/SQL procedures) or directly to the enterprise database itself via ODBC. As with all of the ODBC connectors the dynamically interrogation of the RDBMS schema is automatically executed, exposing the specific physical design of the database. This gives the customer a hierarchical view of the actual interfaces into that system.

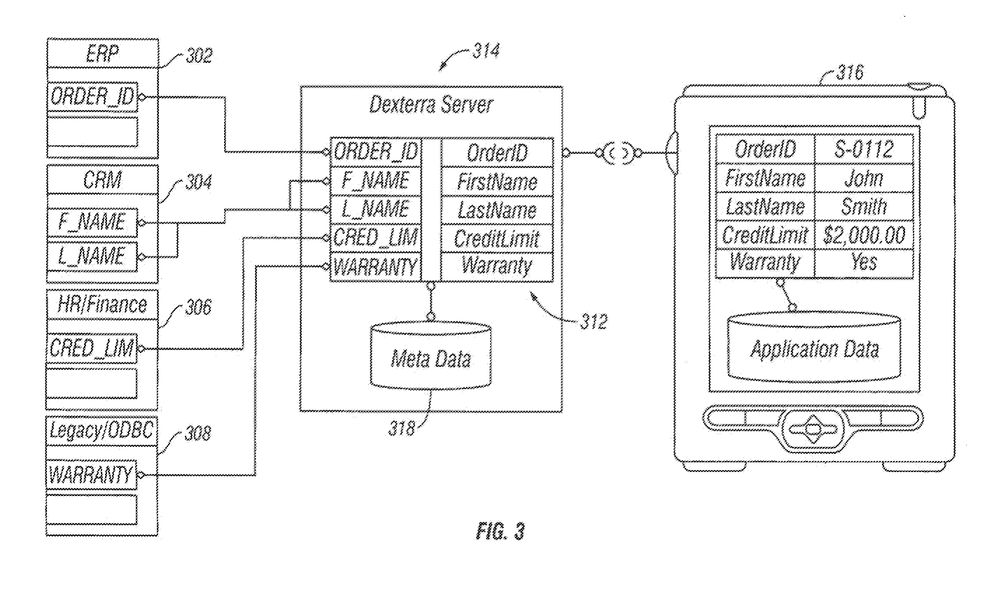

FIG. 3 shows an example of how the Connectors interface the enterprise data sources to the mobile enterprise platform. On the left side of FIG. 3 are representations of multiple enterprise data sources, including an ERP data source 302, a CRM data source 304, an HR/Finance data source 306, a Legacy/ODBC data source 308, and can include other Web Services or other sources (not shown). In the middle portion of FIG. 3 is a representation of the metadata 312 that specifies to the application server 314 how data from the different enterprise data sources will be stored and related in the mobile client 316, which is represented at the right side of FIG. 3.

Thus, in this example, data identified as ORDER_ID exists in the ERP data source. Data identified as F_NAME and L_NAME exists in the CRM data source. Data identified as CRED_LIM exists on the HR/Finance data source, and data identified as WARRANTY is stored in the Legacy/ODBC data source. All of these identified data are stored in enterprise data sources, such as at back-end office systems.

In the metadata 312, the data definition from the enterprise data sources is mapped to views that are used to create the data store on the client and store the relevant business data on the mobile client from the enterprise data sources in a relational database. Access to this business data is performed via a the business object layer defined and stored in metadata on the mobile client. As shown in FIG. 3, the ORDER_ID from the ERP data source is mapped to a business object property called OrderID, whos relational definition is stored in metadata 318 on the mobile client 316 and utilized by one or more the mobile applications also defined in metadata. The F_NAME data from the CRM enterprise data source is mapped to (stored into) the FirstName business object property definition stored in the mobile client database, and the L_NAME data is mapped to the LastName business object property. Similarly, the CRED_LIM data from the HR/Finance data source is mapped to the CreditLimit business object property, and the WARRANTY data from the Legacy/ODBC data source is mapped to the Warranty business object propery. Thus, data from the potentially dissimilar and incompatible disparate enterprise data sources 302, 304, 306, 308, 310 are delivered to the mobile client through the Data Manager Web Services to the local data store (represented by the lines from the enterprise data sources to the application server 314) in the proper format for access using one of the business objects on the mobile client (indicated in the mobile client 316 with actual values).

Connector Types

The connectors that are supported by the Connector Web Service include the following three connector types:
1. The Web Services connector is used when the mobile platform is connecting to a third-party system (a) that is either non ODBC-compliant, or (b) does not allow ODBC/RDBMS connectivity, or (c) whose interface is defined by a standard API and can be wrapped and defined by Web Service Descriptor Language (WSDL).
2. The ODBC/RDBMS connector is used when connecting the mobile platform to a third-party system (a) that is ODBC compliant and (b) allows for direct ODBC/RDBMS access and (c) whose data is located physically within the same LAN environment or accessible via a communication protocol supportive of the transport (such as RPC, TCP, etc.).
3. The API connector is similar to the Web Services Connector but (a) requires the API to be accesible via non internet protocols such as RPC and (b) is used if the Web Services Interface is not available.

Reading schema, via the ODBC/RDBMS connector, information is accomplished through the use of the Studio portion 130 (FIG. 1) of the mobile enterprise platform, using the Administrator application. The Studio portion is used to configure the View definition mapping to the backend data source and map the definition of one or more Views to one or more Business Objects. When defining the View definition or mapping the Views to Business Objects, using the administrator, the information is stored as metadata. During an update process with the application server and enterprise data source, the metadata is read to determine how to read, persist and remove the data (select/insert/update/delete functions) while managing and enforcing the data integrity using such functions as conflict detection/resolution, transactions both inherent and compensating where appropriate.

Using the ODBC/RDBMS connector, data is read, persisted and/or removed via ANSI SQL statements and/or stored procedures in the case of Microsoft Corporations SQL Server or Oracle's RDBMS (8i, 9i, etc.). Using the Web Services/API connector, data is read, persisted and/or removed by calling the appropriate API function or method for the transaction.

2. Configuration Web Service

The Configuration Web Service consumed by the Dexterra Studio provides an easy interoperable way for administrators, business analysts and developers to implement, configure, and administer the Dexterra Mobile Enterprise solution. The Configuration Web Service allows for easy manipulation of the metadata used to configure and customize the data and process definitions of Mobile applications. This service will be better understood with reference to the features of the Administrator component, which is described in greater detail below.

3. Data Manager Web Service

Update Process Model

An update process model is utilized in the system, in which mobile applications update their locally held data (either the application or its business objects) with the backend enterprise database using a set of core Net components that are exposed as Web Services for easy interoperability.

The Data Manager Web Service updates the mobile application and all its associated business objects defined data. The Update process model enables two-way data transfer between the enterprise datasources via the Dexterra application server and the mobile client, allowing updates to be made while the mobile client is connected to the network, merging the updates between clients when they are connected. When in the disconnected state, updates are managed in the client environment, until a time at which a connected state is attained and the update request can be initiated.

The update process model takes the “all or nothing” approach. If a failure occurs before the entire stream is downloaded from the application server onto the mobile client (or before the entire stream is uploaded from the client to the server), then the Data Manager Web Service on the application server does not receive a confirmation on the download transaction (or upload). As a result, the server carries the intelligence to manage the client state as to whether it requires a roll back of data or simply a retry. When the mobile client performs an update process operation the second time, the application server takes into account the original information state and may either deliver the results if the application server has processed or process again in the event all the required information was never received by the application server thus enforcing the reliable deliver of information once and only once between the mobile client and application server. This, in event, enforces the integrity of the data as it moves from mobile client to one or more back end data sources.

Update Process Breakdown

Two types of update processing are supported:
1: Get Latest: In this update type, the mobile client makes a request to get the latest information from the enterprise data sources via the Dexterra application server. The Dexterra application server process the request and retrieves the business information from the multiple data sources using the Dexterra Connector Web Service and delivers the business information to the mobile client.
2: Update (2-way update): In this update type, records on both the client and server end are interchanged enforcing the integrity of the data on both the mobile client and the back end enterprise data sources using Dexterra Conflict Resolution configured parameters.

Conflict Detection/Resolution

Conflict resolution describes the rules used to arbitrate on data conflicts caused by changes made between a mobile client and one or more back end enterprise data sources. This is performed first by identifying the conflict (Detecting) and then resolving (Resolution) the conflict in one or more various ways.

The Dexterra application server can detect conflicts in one of three ways: Revision, Date/Time Stamp or Manual as well as identify a conflict situation by row or column level.

Revision is a setting where a specific field or property is identified in a single record source as revisioned and the Dexterra application Server will use this to determine whether data has been changed on either the back end data source or the mobile client.

Date/Time Stamp

Date/Time Stamp is a setting where a specific field or property is identified in a single record source as date/time stamp and updated upon any insert/update or delete and the Dexterra application Server will use this to determine whether data has been changed on either the back end data source or the mobile client.

Manual is a setting where there is no specific field or property to identify a conflict situation in a single record source therefore the Dexterra application Server compares all the field or property data to define uniqueness and detect whether data has been changed on either the back end data source or the mobile client.

Depending on configuration of the Dexterra application Server, Conflicts are resolved in one of four ways: First Update Wins, Last Update Wins, Admin Resolution or Server-side Rule

First Update Wins

Under the First Update model the application server will only accept changes of any record that is the first one to make an update. If a record is first updated by the back end data source and a conflict is detected by the Update Web Service, instead of returning an error, the Data Manager Web Service will drop the version provided by the client and return a copy of the latest version of the record from the back end enterprise data source to the mobile client.

Last Update Wins

Under the Last Update Wins model, the server need not detect conflicts. Instead, it simply persists the changes from the mobile client to the back end enterprise data source overwriting the current record in the back end enterprise data source.

Admin (or Manual) Resolution

When configured for Admin/Manual resolution, the server will treat all conflicts as requiring manual intervention to resolve and will return a copy of the current record from the back end enterprise data source and optionally notify via any nofitication service (SMS, Emai, etc.) that a conflict situation has arisen and allow for resolution via the Dexterra Administrator. Doing so allows for column level conflict resolution since the Administrator determines the values to reapply back to the back end enterprise data source selectively.

Server Side Rules

Customizable Server Side Rules can be created to determine more programmatically and specifically how certain conflict situations should be resolved. For example, a conflict may be resolved based on the values of data in a record. This flexibility allows for complete control over the specific actions surrounding a conflict resolution scenario.

Client Deployment from the Server

The application server contains the definition of one or more mobile field applications that are to be downloaded to the mobile client, including the Forms/screens represented as tasks (referred to as “FormFlows”), data-interactions (referred to as a “FieldFlow”), and groups of FormFlows and FieldFlows constructed into a Business Process/Workflow (called a “ForceFlow”). The FormFlows, FieldFlows, and ForceFlows are described further below. The application definition also includes the configured metadata associated to an application such as View, Business Object, Business Constants definition. Also included in the deployment is the specific business data from one or more back end enterprise data sources required to run the mobile client in an “occasionally” connected state.

The application server provides the foundation on which to deliver and manage applications and to connect to existing enterprise data sources and systems. The mobile enterprise platform applications are distributed and managed to the mobile devices, such as Pocket PC and Tablet PC devices, by the application server, providing a highly manageable administration of all user interfaces in the field.

C. Administrator Component

As noted above, the Administrator component (FIG. 1) allows system administrators to perform changes that are relatively regular or frequent. The Administrator component provides access to decision variables, drop-down list content, and other information in a format appropriate for business analysts or administrators to manage. This approach to administration allows system administrators to extend many functions down to the Administrator level without compromising system integrity.

For example, data comprising business information that is used to define the business processes of the enterprise can be received through a Business Objects definition form. The Configuration Web Service provides access to this aspect of the Administrator component.

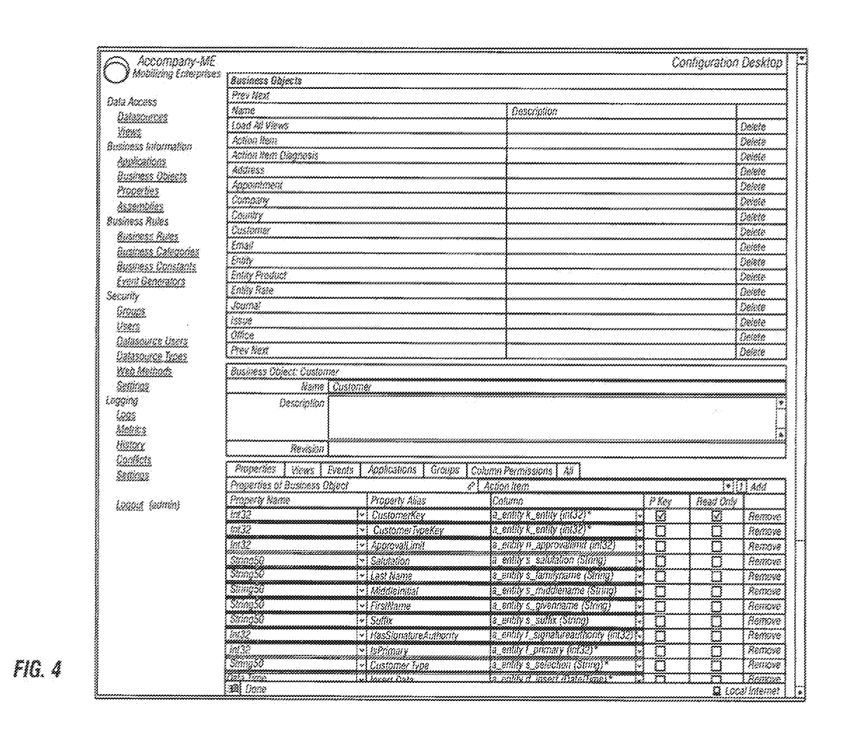

FIG. 4 is a screen display for a Business Objects window of the Administrator component application. This application is executed at a computer desktop as part of the “Studio” portion 130 of the system (FIG. 1). The FIG. 4 screen page shows that a customer administrator may choose from a list of Business Objects and, for a selected Business Object, may provide a description. Properties for the selected Business Object also may be selected, from a list. In this way, an easy-to-use interface is provided for configuring and modifying the application that is installed onto the mobile devices.

Managing Security

The design of the system and of the Administrator component supports security management features that provide a mechanism to add and change users, integrating with existing directory services and/or LDAP or Active Directory Services in a “two tiered” security model. The security management then “authorizes” that client based on the information received in the authentication process to determine who the client identified. Thus, a high level of security is provided, because the application is secure on the client (requires username/password for access) and the downloaded data is secure on the client, and the system access (through the SQL CE interface) is controlled. There is a “device disablement” process built Into the system through the configuration desktop, and a user can be disallowed access to the device application and data. Additionally, there is a significant amount of history tracking, logging, and metrics built into the system for auditing purposes. Other models of security are supported, including IIS Authentication support and DB/third-party system level security/authentication, all over Secure Socket Layer (SSL).

FIG. 5 shows a screen display for a Groups window of the Administrator application, which is a portion of the Studio component. As shown in FIG. 5, the configuration management supported by the mobile enterprise platform permits defining Groups for which security will be managed, and permits identification of administrators for the defined Groups within a Role Based model. Finally, for each Group, a level of administrative permissions can be selected from a list. Thus; this page of the configuration service application provides a convenient means of managing security features.

Security Settings

Fast, efficient, reliable connectivity to existing enterprise applications and data stores is important to the operation of the system. The application server provides services for fast integration to existing enterprise data sources and installed software applications, such as Siebel systems or Oracle systems, or to custom in-house developed systems.

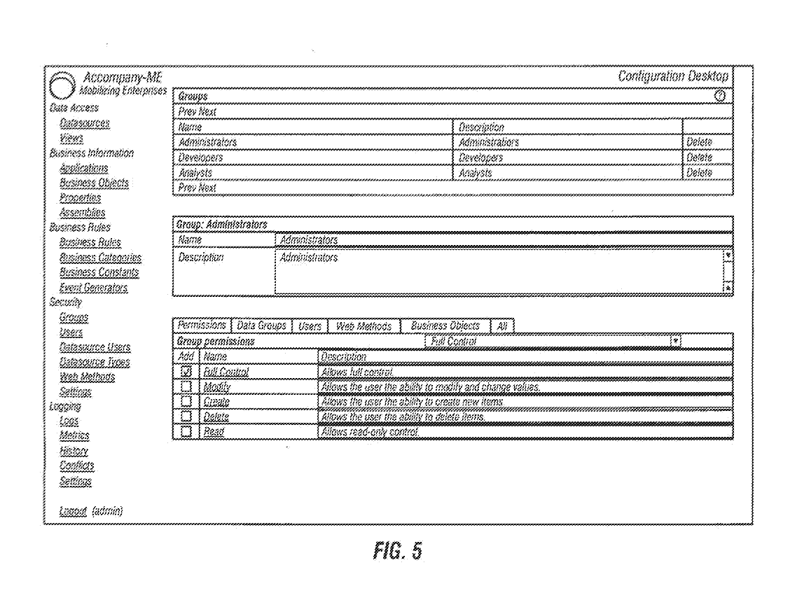

FIG. 6 shows a screen display for a Security Settings window of the Administrator component. For each enterprise data source, the Security Settings window permits an administrator to define a server name and access connection string, as well as corresponding mobile client information for the client datastore of such data. Other security settings can be specified through the Security Settings window, such as authentication, authorization, and synchronization data settings.

Performance monitoring is supported to allow visibility into performance of the application server and other administrative functionality. The performance monitoring includes an error logging capability.

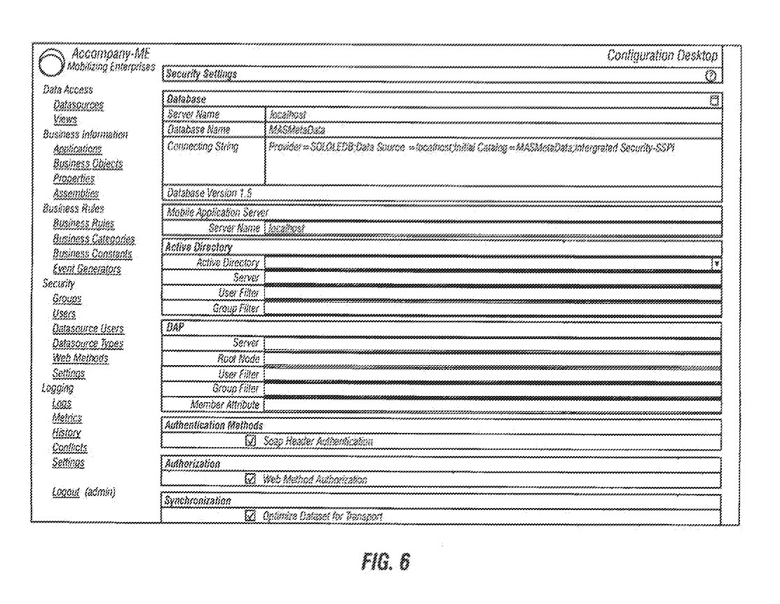

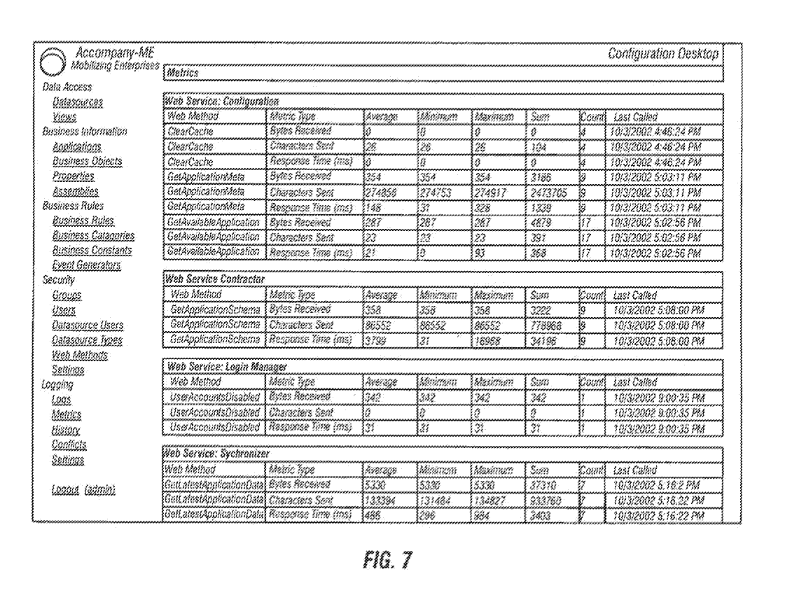

FIG. 7 shows a screen display for a Metrics window of the Administrator component, which illustrates the types of system performance metrics that can be selected for logging. As illustrated, Web Services can be selected and configured, connectors can be specified, and login and synchronization operations can be selected for tracking.

Dexterra Studio Developer

A feature called “Dexterra Studio Developer” allows the programmer to perform changes to the mobile application. In the illustrated embodiment, the Dexterra Studio Developer is deployed as plug-ins to the Microsoft VS .NET Integrated Development Environment (IDE) using Visual Studio Automation. The Dexterra Studio Developer provides professional services and engineering personnel with a robust, object oriented workspace in which to develop screens, define workflows, and create User Interface elements that enforce business rules using a common development environment and language such as Microsoft Corporation VB.NET or C#. A series of designers helps guide the user through specific steps of application development without reducing the power of this application development platform. These designers help the programmer create forms and steps that bind to the defined metadata, using the Configuration Web Service, that will interact effectively with the Dexterra application Server at runtime, thereby extending the flexibility and power of the system for any administrative information or back end configuration that may require more rapid or frequent change.

D. Client Component

As noted above, the client 102 (FIG. 1) in the enterprise platform architecture provides a framework in which the mobile application allows the use of role-based business processes using techniques referred to as “ForceFlow”, “FieldFlow”, and “FormFlow”, and using Web Services, thus enabling communications between the mobile client and the Dexterra application Server and the enterprise data sources over a LAN/WAN network, such as the Internet, via wired and wireless connections. The mobile application running on the client devices functions in a manner that is optimized for small form-factor devices providing an exception, easy to learn user experience.

In the illustrated system, the client is an object framework that is built utilizing the “.NET Compact Framework” of Microsoft Corporation that is metadata aware. The client component enables delivery of enterprise-class application functionality on the mobile devices, which preferably operate according to the “PocketPC” operating system or Microsoft Tablet PC operation system from Microsoft Corporation. The client component also integrates with existing “PocketPC” functionality to provide seamless integration with Calendar, Task, and Today screen functionality of the PocketPC interface. It thereby provides a stable, effective environment in which to work.

FormFlows, FieldFlows, ForceFlows

Any business process tasks or steps or operations in the form of display screens are called “FormFlows”. The FormFlows are used to initiate process interactions called “FieldFlows” that allow the initiation of business processes, which are referred to as “ForceFlows”. The FieldFlows allow launching of “out of band” ForceFlows to bring real-world elasticity to the business processes.

The FormFlows are broken into three categories: (1) Information; (2) Activity; and (3) Update. An Information FormFlow is a screen that shows information needed by a mobile user to fulfill the next logical task in the business process. An Activity FormFlow is a screen that shows something the user may need to do or perform. An Update FormFlow is a screen that is displayed when a mobile user is prompted to enter data that will be returned to the host applications (the enterprise data sources).

A FieldFlow may be required, for example, when a part might have failed and a search of inventory databases might need to be performed to see if any matching parts or similar problems with solutions exist and are available, called a lookup, or a FieldFlow may be required when a part might need to be ordered or assigned or scheduled for delivery to the client, a FieldFlow called an update.

A ForceFlow is a business process, and therefore is a collection of FormFlows and FieldFlows. An example of a ForceFlow would be time, travel, and expense recording that is associated with a job or dispatch event.

Referring back to FIG. 2, this block diagram shows how the relationships between columns and fields in the target application are related to information In the “FormFlows” (steps in the business process represented as ‘Forms” in the application) and are then associated into the ForceFlow (the business process). There can be many Business Objects in one FormFlow and potentially more than one FormFlow in any business process.

Filters allow characteristics and conditions to be placed onto the data when referenced in the mobile application. For example, data type (e.g., Date), valid types (e.g., only Monday through Friday), and any conflict conditions may be detected. Other filter characteristics and conditions can be configured.

Views define the data and storage location for use in one or more Business Objects, and the Business Object can be based on one or more Views. This allows additional characteristics to be associated. For example, a Business Object may be referred to as “Customer”, which may Include standard customer details; location, contacts, inventory, and also SLA and other attributes that the application would like to classify as Customer but not held in the same Target table or even Target application.

### V. Operation and User Interface

The operation of the mobile enterprise platform will be better understood with reference to the following description of how an end user at a mobile client will utilize the mobile application and communicate with the application server to process business information from enterprise data sources in real time. The following example illustrates operation for a mobile application that comprises a field services application, such as for a field service technician (repair).

Initially, at the start of a business day or initiation of a service run, an end user (the field service technician) would start the mobile application and initiate an Update operation that downloads service call dispatch information and the like. During the Update operation, the application server would ensure that the mobile client contains the application data and business information necessary for operation of the mobile application and the latest set of tasks (field service calls). As noted above, the business information might come from a variety of different enterprise data sources. The business information might include the customers to be visited, the products to be serviced, parts that might be needed for repair, and the like. After the Update has been performed, there is no need for a network connection (wired or wireless) for operation of the client application.

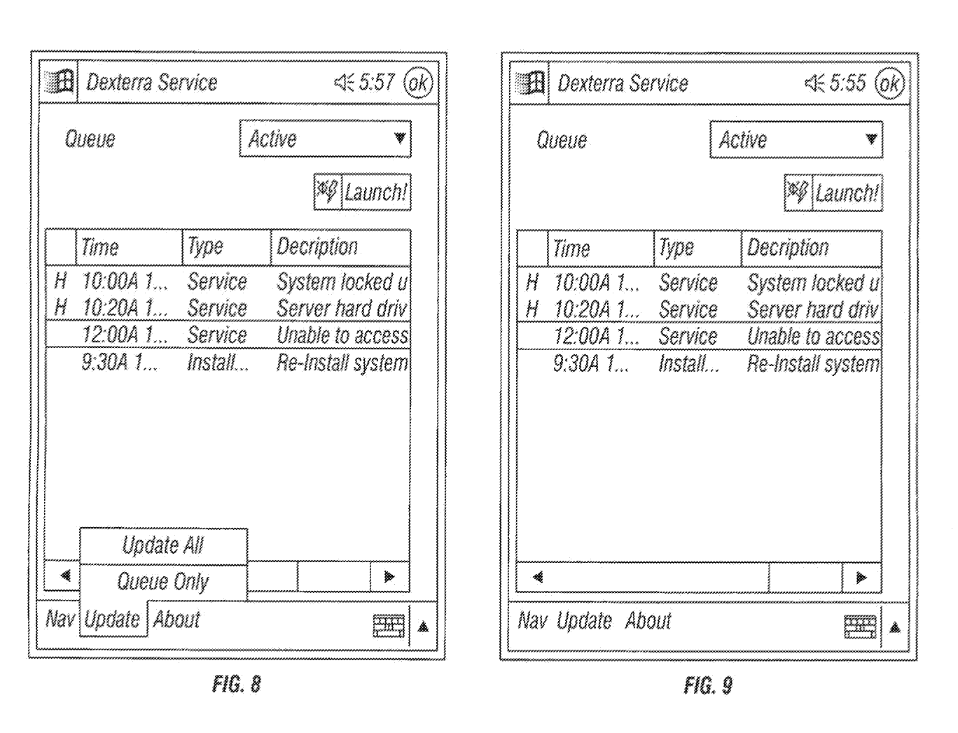

FIG. 8 is an illustration of a display screen 802 from the mobile client, showing a “Queue” page that is generated by the mobile application after the Update operation is performed. The Queue page represents a FormFlow of the mobile application. The Queue page shows a repair queue of customers who have requested a service call.

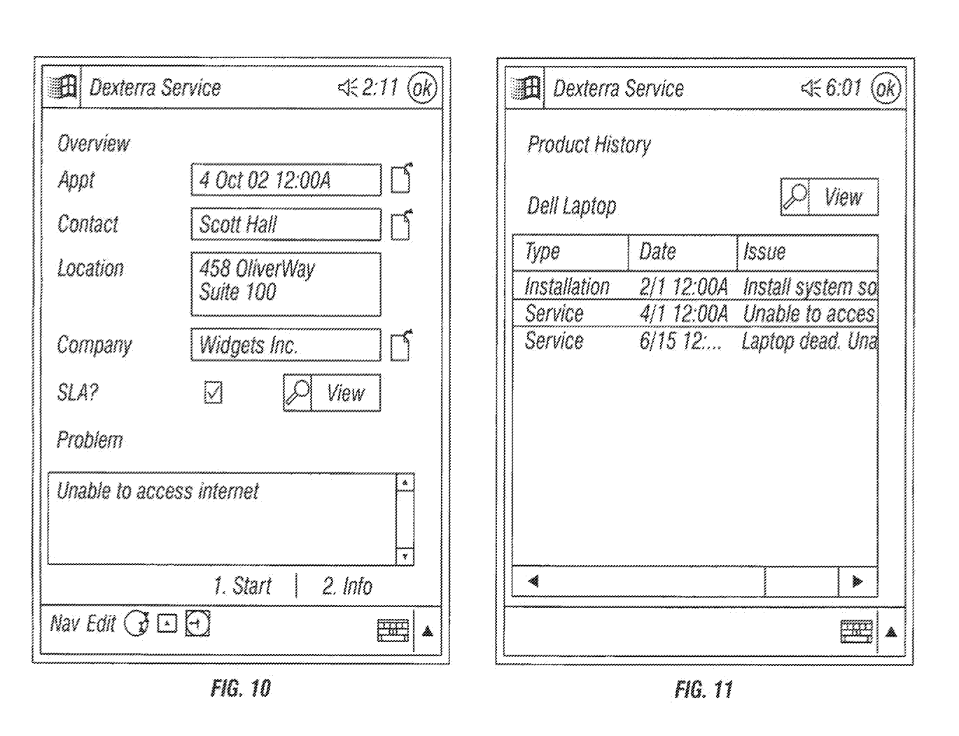

When the field service technician arrives at a customer who is listed in the repair queue, that customer is selected from the Queue page display and the next business operation is launched, as indicated by the arrow cursor at the “Launch” display button in the display page of FIG. 9. This operation can launch another display page (a different FormFlow, specified as part of the business process via a FieldFlow), such as the “Overview” display page illustrated in FIG. 10. The Overview page is a page from which other displays (other FormFlows) can be selected, again determined by the downloaded metadata of the mobile application. For example, the Overview page can permit the service technician to determine the level of service to which this customer has subscribed. An “Information” display button can be selected to initiate a “Product History” display page, illustrated in FIG. 11. The Product History page shows information for the product to be serviced. The full product history can be called up for viewing by selecting a “View” display button. Again, this sequence of display pages is determined by the ForceFlow information and the associated data (FieldFlows, FormFlows) that is stored in the mobile client.

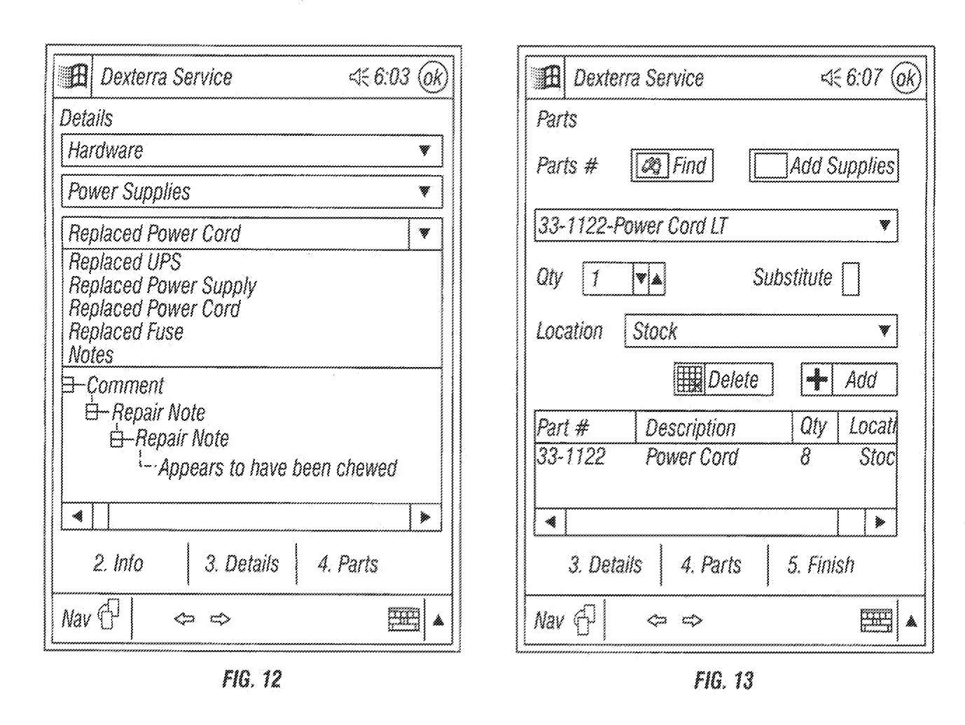

When the service technician determines what action is necessary to effectuate repair, that action can be documented via another display page, which is illustrated in FIG. 12 as a “Details” page. Other service actions, such as ordering repair parts, can be initiated by selecting other display buttons, such as “Parts” at the bottom of the FIG. 12 display page.

FIG. 13 shows a “Parts” display page, which the service technician can use to order the appropriate repair parts. It should be noted that all the aforementioned data interactions (product history, parts information, ordering form) are generated and navigated to and interacted with by the service technician without a network connection. That is, following the Update operation, there is no need for network connection for the mobile application to operate.

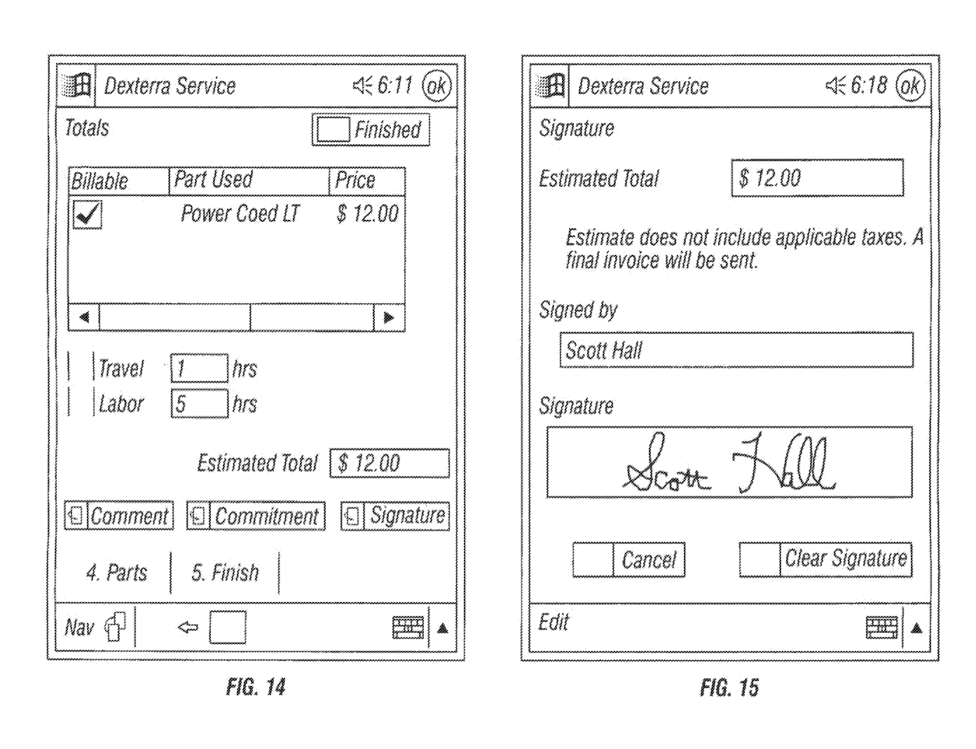

At the completion of the service call, the technician (the mobile user) can enter service call information, such as the elapsed time for repair. An exemplary data collection display page is shown in FIG. 14. The mobile device can also support collecting a customer signature or other acknowledgment of the service call, as illustrated in FIG. 15.

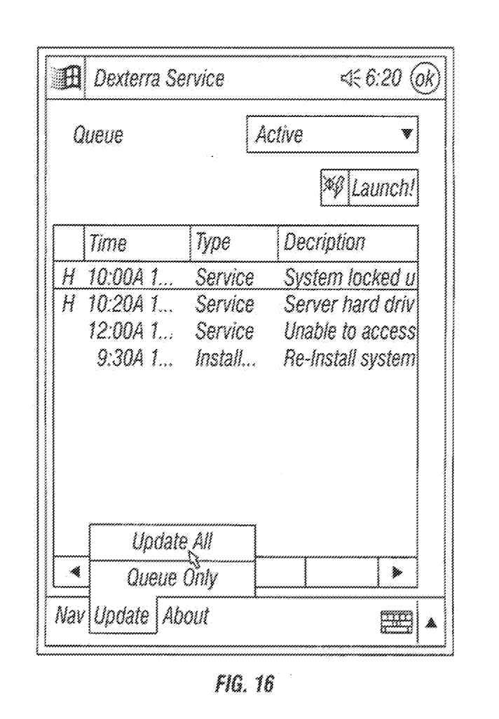

Finally, after the completion of the service call, the field service technician who performed the repair will eventually reach a geographic location where wireless connection to the network is once again possible. The mobile application can attend to automatically uploading the data changes to the application server. The data changes will include all of the data entered by the technician, such as the customer visited, repair diagnosis, parts ordered, and customer data collection. The Queue display will then be updated and the technician can proceed to the next location in to the service queue, as illustrated in FIG. 16.

Thus, the mobile application can operate efficiently by downloading operational data when connected (wirelessly) to a network, such as the Internet. The business processes of the mobile application can be performed thereafter in a disconnected state, free of a network connection. Thereafter, data uploads can be achieved when connectivity is restored. When connected to the network, data can be received from, or uploaded to, the enterprise data sources in real time through the Connectors at the application server. The data from the enterprise data sources is never accessed directly by the mobile client and is never stored in the mobile client in its native format, but rather is stored in a relational database store of the mobile client, as configured for purposes of the mobile application.

An initial operation for the mobile client, before the mobile application itself is loaded and installed, is to make an initial request to the application server to select and download an application onto the mobile device. An application server can support and service any number of applications from field sales to field service. When a mobile client receives an application, it receives metadata and associated data files that make up the mobile application. The data is downloaded by making requests to Web Services located on the application server. Requests to Web Services are made using the Simple Object Access Protocol (“SOAP”) transmitted in a standard HTTP request. The results are then returned to the device as XML using SOAP. The client device then parses the returned XML and updates the necessary data on the client device.

The mobile application metadata is stored in a (e.g., a SQL CE database file) metadata file on the mobile client device. As noted above, the metadata is the actual definition of the application and how it behaves, comprising Business Objects and associated data. As described above, Business Objects are individual components of the mobile enterprise system that are broken up into logical pieces of business such as Customers, Orders, Products, and Product Issues. A Business Object property is a specific attribute of a given Business Object such as a Customer First Name, Last Name, Address and SSN. The Business Objects also specify business rules that are individual pieces of logic applied to a Business Object to help control the behavior and state of the object, (e.g., placing an Order for a platinum Customer automatically gets overnight shipping for no charge). Other data comprises business constants data, which help control and determine the outcome and criteria for a given business rule, such as a rule where a customer type has to be Platinum, Gold, or Silver to get overnight shipping. These business constants are used in the business rules to determine the outcome. The metadata is downloaded in a highly normalized format down to the device and then inserted into the stored metadata file. This allows for quick and easy creation of the Business Objects on the fly by the mobile application.

The Customer Business Data is the actual data stored in the back-end system, which is then downloaded onto the client device and then inserted into the tables that are created in the Customer Business Data file during the creation of the Customer Data Definition. As noted above, the Customer Business Data is first converted by the connectors into an appropriate data format for storage into the relational database of the mobile client. This data gives the end-user (the field service technician) a basis on which to begin using the mobile application and to update data and download only the changes that have occurred on the application server since the last time the latest data was downloaded to the mobile application.

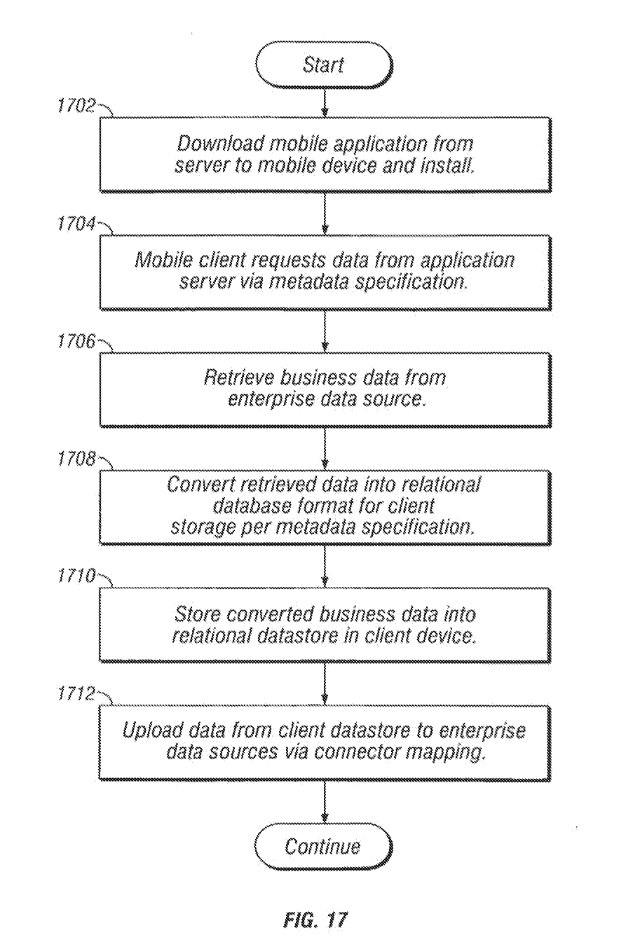

FIG. 17 is a flow diagram that illustrates operation of the mobile enterprise platform to share data between multiple enterprise data sources and mobile clients. In an initial operation represented by the FIG. 17 flow diagram box numbered 1702, a mobile application is downloaded from an application server to a mobile client and is installed. The downloaded information will include metadata that specifies Business Objects and corresponding business rules and specifications for business processes, as exemplified by the ForceFlows, FieldFlows, and FormFlows described above.

After the mobile application is installed on the mobile client, the mobile client can operate in cooperation with the application server and the enterprise data sources of the mobile enterprise platform configuration. When an end user of the mobile client, such as a field service technician, requires business information data, the mobile client sends a request to the application server for data from the enterprise data sources. The client data request includes metadata that identifies enterprise data sources for the requested data and specifies a relational correspondence between the requested data. This operation is represented by the flow diagram box numbered 1704.

In the next operation, represented by the box 1706, the enterprise data is retrieved from the enterprise data sources identified as containing the requested data. This operation is performed through the Connectors and Web Services scheme of the application server. At box 1708, the retrieved data is then converted into a relational database format that relates the retrieved data from the enterprise data sources, in accordance with the relations specified by the metadata sent by the mobile client.

The converted data is then stored in a relational datastore in the mobile client, as indicated by the flow diagram box numbered 1710. In the case of uploading data from the mobile client back into the enterprise data stores, the application server can apply the Connectors to map the data received from the mobile client back into the enterprise data sources for storage, as indicated by the flow diagram box numbered 1712. In this way, data is shared between mobile clients and enterprise data sources without need for interim data storage, utilizing a metadata based scheme for more efficient operation.

The present invention has been described above in terms of a presently preferred embodiment so that an understanding of the present invention can be conveyed. There are, however, many configurations for mobile enterprise data systems not specifically described herein but with which the present invention is applicable. The present invention should therefore not be seen as limited to the particular embodiments described herein, but rather, it should be understood that the present invention has wide applicability with respect to mobile enterprise data systems generally. All modifications, variations, or equivalent arrangements and implementations that are within the scope of the attached claims should therefore be considered within the scope of the invention.

We claim:

1. A method of processing data that is shared between multiple enterprise data sources and a mobile client, the method comprising:
receiving a request from the mobile client for enterprise data used by a client application, wherein the client request includes metadata that identifies enterprise data sources for the requested data and that specifies a relational correspondence between the requested data;
retrieving the enterprise data from the enterprise data sources identified as containing the requested data;
converting the retrieved data into a relational format that defines the retrieved data from the enterprise data sources, in accordance with the relations specified by the metadata; and
storing the converted data in a relational data store in the mobile client.

2. A method as defined in claim 1, wherein the metadata describes business processes that are executed by the client application.

3. A method as defined in claim 1, wherein the metadata is received at the mobile client from an application server.

4. A method as defined in claim 3, wherein the mobile client requests the metadata during an initialization operation of the client application.

5. A method as defined in claim 1, wherein the metadata specifies a View into an enterprise data source that exposes the data schema of the enterprise data source so an application server can process data into and out of the enterprise data sources.

6. A method as defined in claim 5, wherein the metadata specifies conflict detection and resolution parameters that resolve data conflicts between the mobile client and multiple back end enterprise data sources.

7. A method as defined in claim 1, wherein the mobile application includes multiple display pages and each display page is associated with metadata that specifies a flow to another display page, thereby comprising a business flow.

8. A method as defined in claim 1, wherein the metadata specifies a business object layer of data that defines objects in a relational database format such that converted data from multiple enterprise data sources can be related together.

9. A method as defined in claim 1, further including receiving upload data from the mobile client and determining a corresponding enterprise data source to which the upload data should be sent.

10. A method as defined in claim 9, further including applying conflict detection and resolution rules to determine if the upload data from the mobile client should be stored in the corresponding enterprise data source or if the upload data should be refused.

11. An application server that supports delivering data to mobile clients that can be shared between multiple enterprise data sources and multiple mobile clients, the application server comprising:
a data manager that receives a request for data from the mobile client, processes metadata in the client data request to determine the data to be retrieved and the enterprise data source from which the data is to be retrieved; and
one or more connectors that retrieve the data from the enterprise data sources and convert the retrieved data into a relational format that defines the retrieved data from the enterprise data sources, in accordance with the metadata contained in the received request, and that return the converted data to a relational data store on the mobile client.

12. An application server as defined in claim 11, wherein the metadata describes business processes that are executed by the client application.

13. An application server as defined in claim 11, wherein the metadata is received at the mobile client from an application server.

14. An application server as defined in claim 13, wherein the mobile client requests the metadata during an initialization operation of the client application.

15. An application server as defined in claim 11, wherein the metadata specifies a view into an enterprise data source that exposes the data schema of the enterprise data source so an application server can process data into and out of the enterprise data sources.

16. An application server as defined in claim 15, wherein the metadata specifies conflict detection and resolution rules that resolve data conflicts between the mobile client and the enterprise data sources.

17. An application server as defined in claim 11, wherein the mobile application includes multiple display pages and each display page is associated with metadata that specifies a flow to another display page, thereby comprising a business flow.

18. An application server as defined in claim 11, wherein the metadata specifies a business object layer of data that defines objects in a relational database format such that converted data from multiple enterprise data sources can be related together.

19. An application server as defined in claim 11, further including receiving upload data from the mobile client and determining a corresponding enterprise data source to which the upload data should be sent.

20. An application server as defined in claim 19, further including applying conflict rules to determine if the upload data from the mobile client should be stored in the corresponding enterprise data source or if the upload data should be refused.

21. A mobile client that processes data from multiple enterprise data sources over a mobile network, the mobile client comprising:
an application that performs data processing functions and generates requests for data;
a data manager that receives data requests from the application and generates a client data request including metadata that specifies enterprise data to be retrieved and specifies the enterprise data sources from which the data is to be retrieved, wherein the data manager transmits the client data requests over the mobile network; and
a relational datastore in which is stored enterprise data from responses to the client data requests, wherein the responses comprise the requested enterprise data from the enterprise data sources, converted to a relational format that relates the retrieved data from the enterprise data sources, in accordance with the metadata contained in the received request.

22. A mobile client as defined in claim 21, wherein the metadata describes business processes that are executed by the client application.

23. A mobile client as defined in claim 21, wherein the metadata is received at the mobile client from an application server.

24. A mobile client as defined in claim 23, wherein the mobile client requests the metadata during an initialization operation of the client application.

25. A mobile client as defined in claim 21, wherein the metadata specifies a view into an enterprise data source that exposes the data schema of the enterprise data source so an application server can process data into and out of the enterprise data sources.

26. A mobile client as defined in claim 25, wherein the metadata specifies conflict detection and resolution rules that resolve data conflicts between the mobile client and the enterprise data sources.

27. A mobile client as defined in claim 21, wherein the mobile application includes multiple display pages and each display page is associated with metadata that specifies a flow to another display page, thereby comprising a business flow.

28. A mobile client as defined in claim 21, wherein the metadata specifies a business object layer of data that defines objects in a relational format such that converted data from multiple enterprise data sources can be related together.

29. A mobile client as defined in claim 21, further including receiving upload data from the mobile client and determining a corresponding enterprise data source to which the upload data should be sent.

30. A mobile client as defined in claim 29, further including applying conflict rules to determine if the upload data from the mobile client should be stored in the corresponding enterprise data source or if the upload data should be refused.
